(19) United States
(12) Patent Application Publication
(10) Pub. No.: US 2013/0321215 A1
(43) Pub. Date: Dec. 5, 2013

(54) ANTENNA AND METHOD FOR MAKING THE ANTENNA

(71) Applicants: SHENZHEN FUTAIHONG PRECISION INDUSTRY CO., LTD., (US); FIH (HONG KONG) LIMITED, Kowloon (HK)

(72) Inventors: HAI-TAO JIANG, Shenzhen (CN); ZHAN LI, Santa Clara, CA (US); MEI-WEN FU, Shenzhen (CN); YE XIONG, Shenzhen (CN); XUE-LI ZHANG, Shenzhen (CN)

(73) Assignees: FIH (HONG KONG) LIMITED, Kowloon (HK); SHENZHEN FUTAIHONG PRECISION INDUSTRY CO., LTD., Shenzhen (CN)

(21) Appl. No.: 13/855,888

(22) Filed: Apr. 3, 2013

(30) Foreign Application Priority Data
Jun. 5, 2012 (CN) 201210181704.4

(51) Int. Cl. H01Q 1/38

(52) U.S. Cl. CPC H01Q 1/38
USPC 343/700 MS; 29/600

(57) ABSTRACT

An antenna includes a substrate and an antenna body disposed on the substrate. The substrate includes a first surface and a second surface connecting to the first surface. The antenna body includes a first radiator and a second radiator. The first radiator is disposed on the first surface of the substrate, the second radiator is disposed on the second surface. The first radiator is disposed by pad printing a conductive slurry, the second radiator is disposed by dispensing the conductive slurry.

### BACKGROUND

1. Technical Field

The present disclosure relates to an antenna and a method for making the antenna.

2. Description of Related Art

Many antennas for electronic devices are formed by pad printing. However, pad printing is most suitable for forming antennas on smooth surfaces. When the surface of the electronic device is not flat and smooth, pad printing is difficult to precisely perform.

Therefore, there is room for improvement within the art.

### BRIEF DESCRIPTION OF THE DRAWING

Many aspects of the disclosure can be better understood with reference to the following figure. The components in the figure are not necessarily drawn to scale, the emphasis instead being placed upon clearly illustrating the principles of the disclosure.

FIG. 1 is an isometric view of an antenna in accordance with an exemplary embodiment.

FIG. 2 is another isometric view of the antenna of FIG. 1.

### DETAILED DESCRIPTION

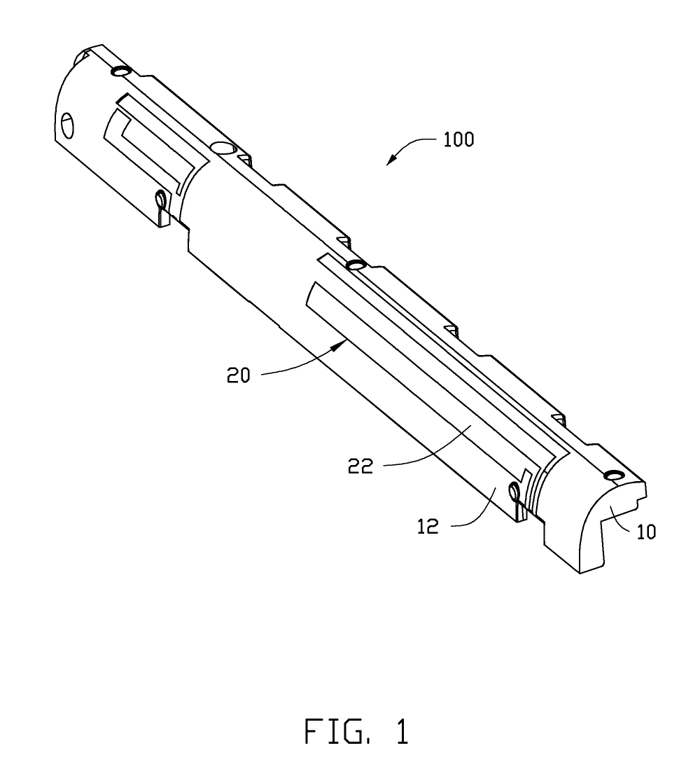

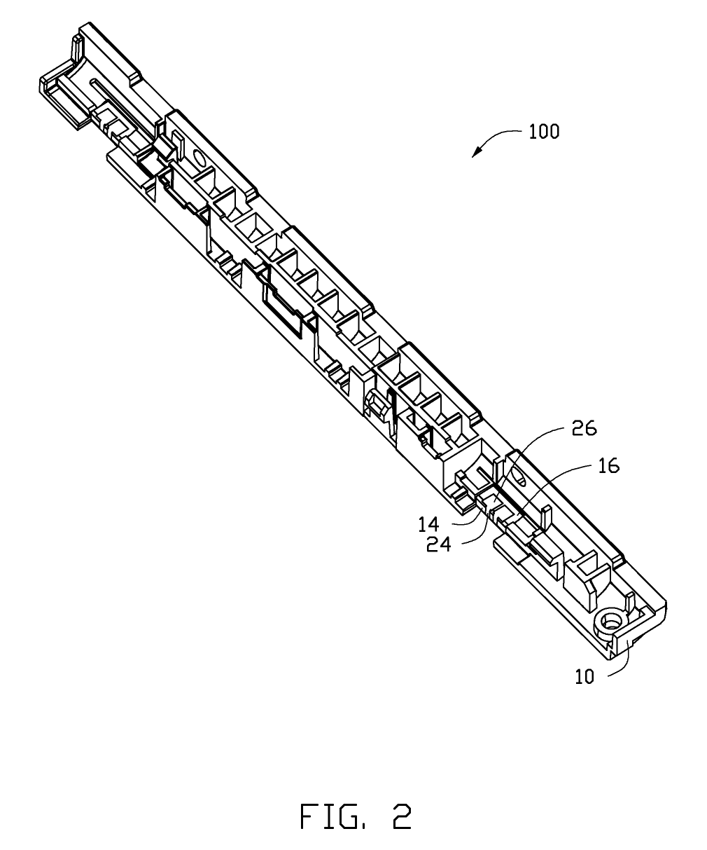

FIGS. 1 and 2 show an antenna 100 according to an exemplary embodiment. The antenna 100 includes a substrate 10 and an antenna body 20.

The substrate 10 has a three-dimensional shape (e.g., has surfaces lying on three different planes). The substrate 10 includes a first surface 12, a second surface 14, and a third surface 16. The third surface 16 is opposite to the first surface 12, the second surface 14 connects the first surface 12 to the third surface 16. The first surface 12, the second surface 14, and the third surface 16 are not on a same plane (i.e., are on three different planes). The first surface 12 and the third surface 16 have areas large enough for pad printing of antennas. The second surface 14 has a small area relative to the first and third surfaces and is too small to be pad printed.

The antenna body 20 is made of conductive slurry which mainly contains silver powder. The antenna body 20 includes a first radiator 22, a second radiator 24, and a third radiator 26. The first radiator 22 and the third radiator 26 are formed on the corresponding first surface 12 and the third surface 16 by pad printing the conductive slurry. The second radiator 24 is formed on the second surface 14 by dispensing the conductive slurry using a conventional adhesive dispenser (not shown). The second radiator 24 connects the first radiator 22 to the third radiator 26.

A method for making the antenna 100 may include the following steps.

A pad printing machine (not shown) is provided. The substrate 10 is positioned in the pad printing machine, and the pad printing machine prints the first radiator 22 on the first surface 12 of the substrate 10 and prints the third radiator 26 on the third surface 16 using the conductive slurry.

A conventional adhesive dispenser, such as a “glue gun” (not shown) is provided. The adhesive dispenser includes a cylinder (not shown) filled with the conductive slurry. The cylinder includes an injector. The substrate 10 is fixed in position relative to the adhesive dispenser, and the cylinder dispenses the conductive slurry on the second surface 14 of the substrate 10 through the injector to form the second radiator 24.

In the exemplary embodiment, the second radiator 24 is formed on the second surface 14 by dispersing conductive slurry instead of printing, thereby even though the second surface 14 may be very small and irregular, the second radiator 24 can still be precisely formed to correspond to a designed shape.

It is believed that the exemplary embodiment and its advantages will be understood from the foregoing description, and it will be apparent that various changes may be made thereto without departing from the spirit and scope of the disclosure or sacrificing all of its advantages, the examples hereinbefore described merely being preferred or exemplary embodiment of the disclosure.

What is claimed is:

1. An antenna, comprising:
a substrate comprising a first surface and a second surface connecting to the first surface; and
an antenna body disposed on the substrate, the antenna body comprising a first radiator and a second radiator, the first radiator disposed on the first surface of the substrate, the second radiator disposed on the second surface;
wherein the first radiator is disposed by pad printing a conductive slurry, the second radiator is disposed by dispensing the conductive slurry.

2. The antenna as claimed in claim 1, wherein the conductive slurry mainly comprises silver powder.

3. The antenna as claimed in claim 1, wherein the substrate has a three-dimensional shape, the first surface and the second surface lie on different planes.

4. The antenna as claimed in claim 3, wherein the first surface has an area larger than the area of the second surface.

5. The antenna as claimed in claim 1, wherein the substrate further comprises a third surface, the third surface connects to the second surface and is opposite to the first surface, the antenna body further comprises a third radiator disposed on the third surface by pad printing, the third radiator connects to the second radiator.

6. A method for making an antenna, comprising:
providing a substrate, the substrate comprising a first surface and a second surface connecting to the first surface;
forming a first radiator on the first surface by pad printing a conductive slurry; and
forming a second radiator on the second surface by dispensing the conductive slurry, the second radiator connecting to the first radiator.

7. The method as claimed in claim 6, wherein the conductive slurry mainly comprises silver powder.

8. The method as claimed in claim 6, wherein the substrate has a three-dimensional shape, the first surface and the second surface lie on different planes.

9. The method as claimed in claim 8, wherein the first surface has an area larger than the area of the second surface.

10. The method as claimed in claim 6, wherein the substrate further comprises a third surface, the third surface connects to the second surface and is opposite to the first surface.

11. The method as claimed in claim 10, further comprising a step of pad printing a third radiator on the third surface, the third radiator connecting to the second radiator.
